(19) United States
(12) Patent Application Publication
(10) Pub. No.: US 2014/0013857 A1
(43) Pub. Date: Jan. 16, 2014

(54) Multiphase Flowmeter and Liquid Film Measurement Method

(71) Applicants: Alexandre Lupeau, Bergen (NO); Andrew Charles Baker, Kleppesto (NO); Sebastien Cadalen, Aubervilliers (FR); Benoit Fournier, Paris (FR)

(72) Inventors: Alexandre Lupeau, Bergen (NO); Andrew Charles Baker, Kleppesto (NO); Sebastien Cadalen, Aubervilliers (FR); Benoit Fournier, Paris (FR)

(21) Appl. No.: 13/990,795

(22) PCT Filed: Jun. 28, 2011
(86) PCT No.: PCT/EP2011/003165

§ 371 Date: Oct. 6, 2013

(30) Foreign Application Priority Data
Jun. 30, 2010 (EP) 10290364.8

(51) Int. Cl. G01F 1/74

(52) U.S. Cl. CPC G01F 1/74
USPC 73/861.04

(57) ABSTRACT

A flow meter apparatus and method are presented for measuring a flow rate of a multiphase fluid mixture comprising at least one gas phase and one liquid phase. The flow meter comprises a pipe section and measurement section through which the mixture flows. The flow meter also comprises a fraction measurement device adapted to estimate a representative fraction of the gas phase and/or liquid phase of the mixture passing at the measurement section. Moreover, the flow meter preferably comprises at least one ultrasonic sensor arranged to estimate a characteristic, such as liquid film thickness or velocity, of a portion of the liquid phase flowing as liquid film along a wall of the pipe section. The characteristic is preferably used to correct the estimated representative fraction of the gas phase and/or liquid phase when the gas phase flows in a core of the pipe section, and a portion of the liquid phase flows partially as liquid film along the wall of the pipe section and another portion of the liquid phase flows partially as liquid droplets in the core of the pipe section.

### TECHNICAL FIELD

An aspect of the present invention relates to a flow meter for measuring a flow rate of a multiphase fluid mixture having at least a gas phase and a liquid phase. Another aspect of the present invention relates to a method for measuring the flow rate of a multiphase fluid mixture and correcting a representative fraction measurement of the gas phase and/or liquid phase using a measurement of the liquid film portion of the liquid phase. Such a flow meter and measurement method may be used, in particular but not exclusively, in oilfield related applications, for example, to measure a flow rate of a hydrocarbon effluent flowing out of a geological formation into a well that has been drilled for the purpose of hydrocarbon exploration and production.

### BACKGROUND OF THE INVENTION

WO 99/10712 describes a flow rate measurement method adapted to oil effluents made up of multiphase fluid mixtures comprising water, oil, and gas. The effluent is passed through a Venturi in which the effluent is subjected to a pressure drop ΔP, a mean value <ΔP> of the pressure drop is determined over a period t₁ corresponding to a frequency f₁ that is low relative to the frequency at which gas and liquid alternate in a slug flow regime, a means value <ρm> is determined for the density of the fluid mixture at the constriction of the Venturi over said period t₁, and a total mass flow rate value <Q> is deduced for the period t₁ under consideration from the mean values of pressure drop and of density.

GB2447490 describes a flow meter apparatus and method for measuring a gas-liquid fluid mixture using enhanced centrifugal separation. The flow meter is described comprising an ultrasonic sensor located at the throat/constriction of the flow meter, capable of ultrasonically measuring the thickness and/or velocity of a liquid layer created by the induced centrifugal separation force.

Such multiphase flow rate measurements are more accurate when the flow mixture distribution is estimated to be substantially homogenous (as in WO 99/10712) or estimated to be substantially separated (as in GB2447490). A mixture is considered as homogenous when its several phases are mixed and dispersed enough to consider the behavior of the mixture as being equivalent to a single phase fluid having similar density and properties. In reality, however, depending on where the multiphase flow meter is installed the incoming multiphase flow mixture is not necessarily homogenous. In such case the common practice is to homogenize the mixture by using a flow conditioner upstream the multiphase flow meter. For example, a blind-T is typically used as a flow conditioner in association with many multiphase flow meters. On the contrary, a technique to separate the gas-liquid mixture into its representative phases is to induce a swirling flow with a swirl element upstream the multiphase flow meter. Where the flow is homogenous, the calculation of the flow rate based on the Bernoulli equation is relevant and can be quite accurate. It is to be noted that, generally, said calculation assumes that the flow rate of the multiphase fluid mixture is proportional to the pressure loss at the Venturi throat which is proportional to the acceleration of an equivalent single phase like fluid mixture through the Venturi throat.

Flow mixture distribution is related to how the gas and liquid are spread/distributed within a pipe. The Venturi measuring section is defined between two pressure ports located at an inlet section and at a throat section of the flow meter. The efficiency of a flow conditioner is not always perfect, resulting in a less homogeneous flow mixture in the flow meter. Furthermore the “degree of homogeneity” of the multiphase mixture, its evolution regarding time, and its position inside the measuring section may also vary depending on various parameters like: fluid properties, flow history, flow meter upstream conditions, and the like. For homogeneous based flow modeling, these variations must remain limited in order to keep such approach applicable while taking certain corrections into account.

If the degree of homogeneity of the flow mixture at the inlet or inside the multiphase flow meter becomes too low, or the degree of separation between respective phases of the flow mixture becomes too low, then the relevant flow modeling approach is less accurate or no longer applicable. Furthermore, the relation between flow rate and pressure drop within the measuring section of the Venturi cannot be modeled correctly. As a consequence, limitations on the accuracy of such a multiphase flow rate measurements may occur when the multiphase fluid mixture is not distributed according to the predetermined modeling approach.

Further limitations on the accuracy may occur when a homogenous based flow modeling approach is applied when the amount of one or several phases of the mixture becomes very low. In particular, this may occur when the Gas Volume Fraction (GVF) in the measuring section becomes very high, for example up to 95%. Indeed, in this case a proper flow conditioning of the multiphase fluid mixture is not guaranteed. Generally, some of the liquid phase is transported by the gas stream at the same speed and some of the liquid sticks to the pipe wall and moves at a lower velocity. As a consequence, a large variety of liquid distribution can be observed, like annular flow, mist flow or annular mist flow. Furthermore, the liquid flows inside the measuring section at different velocities depending on whether it flows in the gas core or on the pipe wall. The split of liquid between the gas core and the pipe wall is difficult, if not impossible, to predict with the current instrumentation technology implemented in differential pressure-based flow meters. In addition, the split of liquid between the gas core and the pipe wall depends on many different parameters like fluids properties, flow rates, internal geometry and pipe flaws.

Thus, there exists a need to perform more accurate flow rate measurements of a multiphase fluid mixture where the use of conventional homogeneous based flow modeling approach is not applicable (e.g., for high gas volume fraction GVF conditions), or where the use of centrifugal induced separation and modeling is not possible.

### SUMMARY OF THE DISCLOSURE

It is an object of the present invention to propose a flow meter and/or a method for measuring a flow rate of a multiphase fluid mixture that overcomes one or more of the limitations of the existing apparatus and methods.

According to one aspect of at least one embodiment of the present invention, there is provided a flow meter for measuring a flow rate of a multiphase fluid mixture comprising at least one gas phase and one liquid phase. The flow meter preferably comprising a pipe section through which the multiphase fluid mixture flows, the pipe section comprising a measurement section. The flow meter also preferably comprises a fraction measurement device estimating a representative fraction of at least one of the gas phase and the liquid phase of the multiphase fluid mixture passing at the measurement section. In accordance with the present implementation, the flow meter further comprises at least one ultrasonic sensor arranged to estimate at least one characteristic of a portion of the liquid phase flowing as a liquid film along a wall of the pipe section. The at least one characteristic being used to correct the estimated representative fraction of at least one of the gas phase and the liquid phase when the gas phase flows in a core of the pipe section, and a portion of the liquid phase flows partially as the liquid film along the wall of the pipe section and another portion of the liquid phase flows partially as liquid droplets in the core of the pipe section.

The measurement section of the flow meter may be defined as a throat of the pipe section and located between an upstream part and a downstream part such as to generate a pressure drop between the upstream part and the downstream part.

The at least one characteristic of a portion of the liquid phase flowing as a liquid film along a wall of the pipe section may be, and should not be limited to, any of the following: a thickness of the liquid film, a velocity of the liquid film, an average velocity of the liquid film, a velocity profile of the liquid film, a frequency of waves along an interface between the liquid film and the multiphase fluid mixture, a velocity of the waves, and an average height of the waves.

The at least one ultrasonic sensor may be positioned at the throat, or measurement section. The at least one ultrasonic sensor may be installed on a face of the pipe section not contacting the multiphase fluid mixture, or may be installed in the wall of the pipe section. Moreover, the at least one ultrasonic sensor may be positioned at a position such as to face a zone of the pipe section where the multiphase flow mixture flows according to conditions similar to the conditions expected at the measurement section. Even further, a plurality of ultrasonic sensors may be positioned on the same plane perpendicular to the multiphase fluid mixture flow direction such as to estimate a mean value of the at least one characteristic of a portion of the liquid phase flowing as a liquid film along a wall of the pipe section.

The fraction measurement device may be a gamma densitometer. Accordingly, at least one of the ultrasonic sensors may be positioned such that ultrasonic waves propagate parallel to a beam of the gamma densitometer.

The flow meter may also comprise pressure tapings and at least one pressure sensor for measuring the differential pressure of the multiphase fluid mixture between the upstream part and the measurement section. In addition, the at least one ultrasonic sensor may be positioned proximate the pressure tapings to define a plane perpendicular to the multiphase fluid mixture flow direction.

The pipe section may be connected at at least on one end to a blind-T pipe section adapted for flow conditioning. Moreover, the multiphase fluid mixture may be a hydrocarbon effluent comprising gas, oil, and water.

According to another aspect of at least one embodiment of the present invention, there is provided a method for measuring a flow rate of a multiphase fluid mixture comprising a gas phase and a liquid phase. The flow rate measuring method preferably comprises generating a pressure drop between an upstream part and a downstream part of a flow meter by flow of the multiphase fluid mixture in a pipe section having a measurement section positioned between the upstream part and the downstream part. The method also comprises submitting the multiphase fluid mixture to gamma rays, measuring an absorption of the gamma rays by at least one of the gas phase and the liquid phase passing at the measurement section and estimating a representative fraction of at least one of the gas phase and the liquid phase in the multiphase fluid mixture.

The flow rate measuring method further comprises estimating at least one characteristic of a portion of the liquid phase flowing as a liquid film along a wall of the measurement section using at least one ultrasonic sensor, and correcting the estimated representative fraction of at least one of the gas phase and the liquid phase based on the at least one characteristic when the gas phase flows in a core of the pipe section, and a portion of the liquid phase flows partially as the liquid film along the wall of the pipe section and another portion of the liquid phase flows partially as liquid droplets in the core of the pipe section. Moreover, the method comprises calculating the flow rate of the multiphase fluid mixture based on the corrected representative fraction of at least one of the gas phase and the liquid phase. The flow meter for measuring the flow rate of the multiphase fluid mixture may enable measuring the degree of annularity of a multiphase fluid mixture in the flow meter. Thus, it may be possible to correct gas fraction measurements by taking into consideration the size of the liquid film in the pipe section where fraction related measurements are performed, said size being estimated by means of ultrasonic measurements.

Furthermore, the ultrasonic sensors can be adapted to be fully non-intrusive, such that the ultrasonic signals passing through the wall thickness of the pipe induces only slight modification of the external pipe structure in order to securely fit the sensors while not introducing any source of fluid leakage.

Other advantages will become apparent from the hereinafter description of the present invention.

### BRIEF DESCRIPTION OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 schematically shows an onshore hydrocarbon well location illustrating various examples of deployment of an embodiment of the flow meter according to one aspect of the present invention.

FIG. 2 depicts a cross-sectional view schematically illustrating an embodiment of the multiphase flow meter of the present invention in a situation of high gas volume fraction GVF.

FIG. 3 depicts a top cross-sectional view schematically illustrating a throat of a Venturi-type flow meter constructed in accordance with an embodiment of the present invention.

FIG. 4 depicts a side cross-sectional view along line 70 of FIG. 3.

FIG. 5 depicts a top cross-sectional view in the throat of a Venturi-type flow meter illustrating a theoretical situation of high gas volume fraction GVF with liquid film on the throat wall and droplets in the throat core.

FIG. 6 schematically illustrates a method for correcting flow rate measurements according to one embodiment of the present invention.

### DETAILED DESCRIPTION

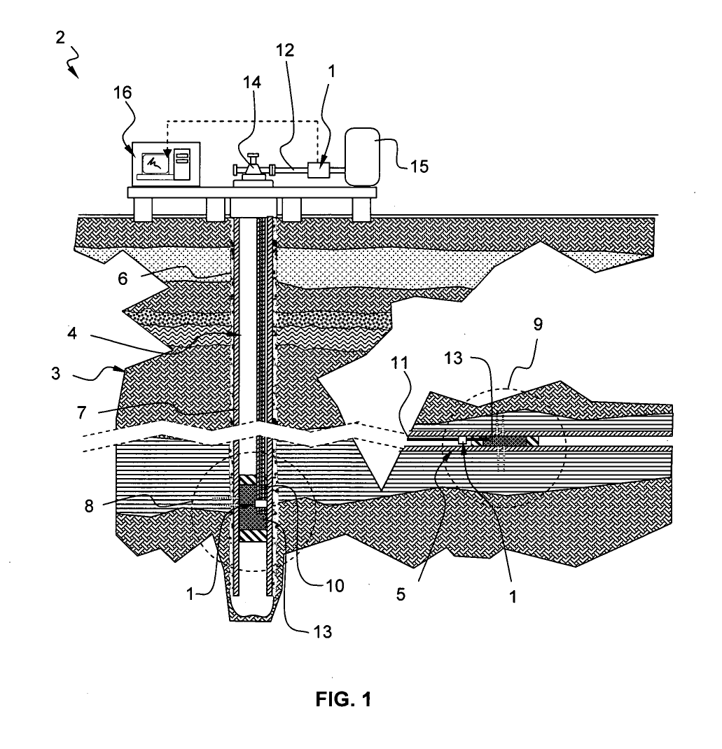

FIG. 1 schematically shows an onshore hydrocarbon well location and equipment 2 above a hydrocarbon geological formation 3 after a drilling operation has been carried out, after a drill pipe has been run, and eventually, after cementing, completing and perforating operations have been carried out, and exploitation has begun. The well is beginning to produce hydrocarbon, e.g. oil and/or gas. At this stage, the well bore comprises a substantially vertical portion 4, and may also comprise horizontal or deviated portions 5. The well bore 4 is either an uncased borehole, or a cased borehole, or a mix of uncased and cased portions.

The cased borehole portion comprises an annulus 6 and a casing 7. The annulus 6 may be filled with cement or an open-hole completion material, for example gravel pack. Downhole, a first 8 and second 9 producing sections of the well typically comprise perforations, production packers and production tubings 10, 11 at a depth corresponding to a reservoir, namely hydrocarbon-bearing zones of the hydrocarbon geological formation 3. A fluid mixture 13 flows out of said zones 8, 9 of the hydrocarbon geological formation 3. The fluid mixture 13 is a multiphase hydrocarbon fluid mixture 13 comprising a plurality of fluid fractions (water, oil, gas) and a plurality of constituting elements (water, various hydrocarbon molecules, various molecules solved in water). The fluid mixture 13 flows downhole through the production tubings 10, 11 and out of the well from a well head 14. The well head 14 is coupled to surface production arrangement 15 by a surface flow line 12. The surface production arrangement 15 may typically comprise a chain of elements connected together, e.g. a pressure reducer, a heat exchanger, a pumping arrangement, a separator, a tank, a burner, etc. (not shown in detail). In one embodiment, one or more multiphase flow meters 1 for measuring at least the flow rate of the multiphase fluid mixture 13 may be installed in fluid communication with the production tubings 10 associated with the first producing section 8, or in fluid communication with the production tubings 11 associated with the second producing section 9 (as represented in FIG. 1) or other sections of the well (not represented in FIG. 1). In another embodiment, one or more multiphase flow meters 1 for measuring at least the flow rate of the multiphase fluid mixture 13 may be installed within the surface flow line 12.

A control and data acquisition arrangement 16 is coupled to the multiphase flow meter 1 of the present invention, and/or to other downhole sensors (not shown) and/or to active completion devices like valves (not shown). The control and data acquisition arrangement 16 may be positioned at the surface. The control and data acquisition arrangement 16 may comprise a computer. It may also comprise a satellite link (not shown) to transmit data to a client's office. It may be managed by an operator.

The precise design of the downhole producing arrangement and surface production/control arrangement is not germane to the present invention, and thus these arrangements are not described in detail herein.

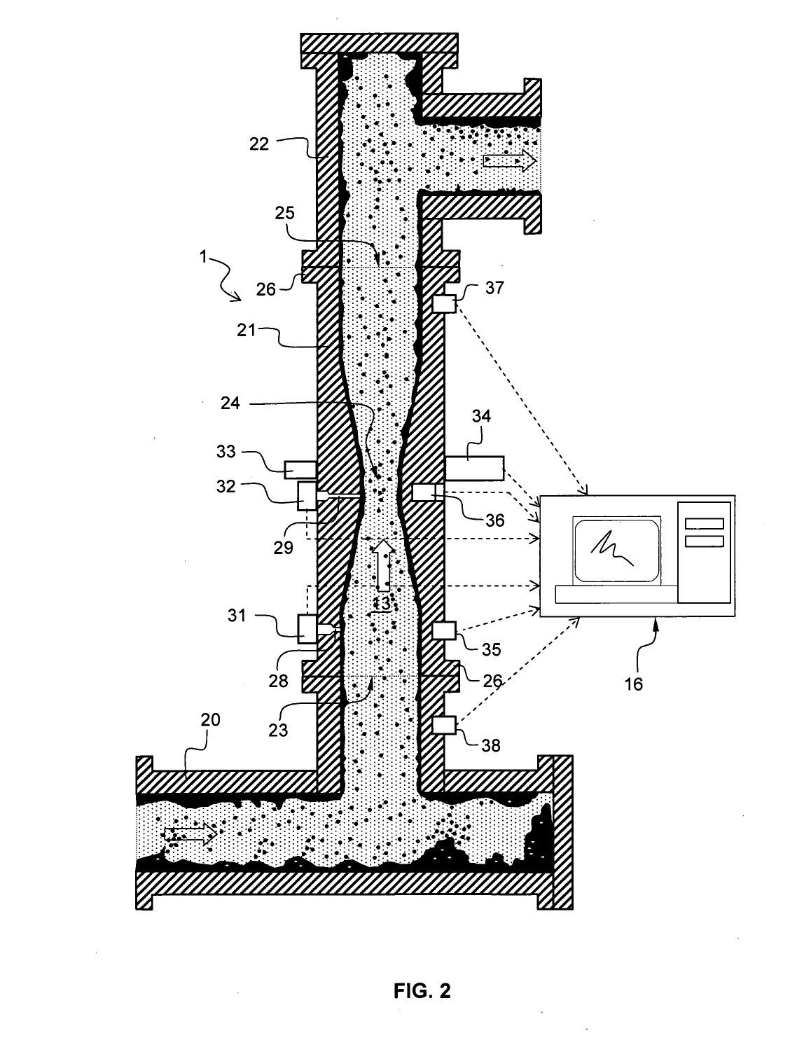

FIG. 2 is a cross-sectional view schematically illustrating an embodiment of the multiphase flow meter 1 of the present invention. The multiphase flow meter 1 measures the flow rates of a commingled flow of different phases 13, e.g. gas, oil and water, without separating the phases. The multiphase flow meter performs additional measurements, in particular on the liquid phase.

The multiphase flow meter 1 preferably comprises a pipe section 21 with an internal diameter that gradually decreases from an upstream part 23 to a measurement section, or throat 24, forming a convergent Venturi, then gradually increases from the throat 24 to a downstream part 25. The convergent Venturi induces a pressure drop between the upstream part 23 and the downstream part 25 encompassing the throat 24. The portion of the pipe around the Venturi throat 24 constitutes the measurement section. The pipe section 21 can be coupled to any flowing line 10, 11, 12 by any appropriate connection arrangement, for example a flange 26 having a bolt-hole pattern and a gasket profile (not shown in details). The multiphase fluid mixture 13 flows through the upstream part 23, the throat 24 and the downstream part 25 of the pipe section 21 as indicated by the arrow. Furthermore, while the multiphase flow meter 1 is described herein as a Venturi for reasons of conciseness, it should be understood that the present invention hereof may also apply to other multiphase flow meters known in the art, such as a V-cone, an orifice plate, or the like.

The pipe section 21 of the multiphase flow meter 1 may be coupled to a first flow conditioner in the form of a blind-T pipe section 20 at the upstream part 23. The multiphase flow meter 1 may also be coupled to a second blind-T pipe section 22 at the downstream part 25. In one aspect of the present implementation, the first blind-T pipe section is adapted to achieve greater homogenization of the fluid mixture 13 entering the inlet of the pipe section 21 of multiphase flow meter 1 compared to the fluid mixture 13 entering the first blind-T pipe section 20. The second blind-T pipe section 22 has no role in conditioning the fluid mixture 13 in the multiphase flow meter. The various pipe sections 20, 21, 22 may be coupled together by the above mentioned flange 26.

Furthermore, the multiphase flow meter 1 comprises various sensing arrangements to measure various characteristic values of the multiphase fluid mixture 13 flowing into the pipe section 21.

In one embodiment, the sensing arrangement is a Venturi flow meter estimating a total flow rate of the multiphase fluid mixture 13 based on a differential pressure measurement. The pipe section 21 is provided with pressure tapings 28, 29. A first pressure taping 28 may be positioned in the upstream part 23. A first pressure sensor 31 is associated with the first pressure taping 28 for measuring the pressure of the multiphase fluid mixture 13 flowing in the upstream part 23. A second pressure taping 29 may be positioned at the throat 24. A second pressure sensor 32 is associated with the second pressure taping 29 for measuring the pressure of the multiphase fluid mixture 13 flowing at the throat 24. Thus, the pressure drop of the multiphase fluid mixture 13 between the upstream part 23 and the throat due to the convergent Venturi can be measured. It should, however, be understood by a person skilled in the art that a differential pressure sensor (not shown) may be positioned between the first pressure taping 28 and the second pressure taping 29 so as to measure the pressure drop of the multiphase fluid mixture 13 between the upstream part 23 and the throat 24, the upstream part 23 and the downstream part 25, or the throat 24 and the downstream part 25.

In another embodiment, the sensing arrangement is a fraction measurement device, for example a gamma densitometer comprising a gamma ray source 33 and a gamma ray detector 34. The gamma densitometer measures absorption of the gamma ray by each phase of the multiphase fluid mixture 13 and estimates a density of the multiphase fluid mixture 13 and a fractional flow rate for each phase. The gamma ray source 33 and the gamma ray detector 34 are diametrically positioned on each opposite side of the throat 24 or close to the throat.

The gamma ray source 33 may be a radioisotope Barium 133 source, or any variety of nuclear sources known in the art of multiphase metering. Such a gamma ray source 33 generates photons which energies are distributed in a spectrum with several peaks. The main peaks of the radioisotope Barium 133 source have three different energy levels, namely 32 keV, 81 keV and 356 keV. As another example, a known X-Ray tube may be used as an alternative to a gamma ray source 33.

The gamma ray detector 34 may comprise a scintillator crystal (e.g. NalTI) and a photomultiplier. The gamma ray detector 34 measures the count rates (the numbers of photons detected) in the various energy windows corresponding to the attenuated gamma rays having passed through the multiphase fluid mixture 13 at the throat. More precisely, the count rates are measured in the energy windows that are associated to the peaks in the energy spectrum of the gamma photons at 32 keV, 81 keV and 356 keV.

The count rate measurements in the energy windows at 32 keV and 81 keV are mainly sensitive to the fluid fractions of fluid mixture 13 and the constituting elements (composition) due to the photoelectric and Compton effects at these energies. The count rate measurements in the energy window at 356° keV are substantially sensitive to the density of the constituting elements due to the Compton effect only at this energy. Based on these attenuation measurements and calibration measurements, the fractional flow rate for each phase and the density of the multiphase fluid mixture 13 can be estimated. Such estimation has been described in detail in several documents, in particular WO 02/50522 and will not be further described in detail herein.

As an alternative to nuclear source-type fraction measurement devices, like the gamma densitometer, other fraction measurement devices may be used, like microwave or X-ray based fraction measurement device.

The multiphase flow meter 1 may also comprise a temperature sensor (not shown) for measuring the temperature of the multiphase fluid mixture 13.

In another embodiment, both sensing arrangements hereinbefore presented may be combined to estimate the total flow rate of the multiphase fluid mixture 13, the density of the multiphase fluid mixture 13 and the fractional flow rate for each phase of the multiphase fluid mixture 13.

Further, the multiphase flow meter 1 comprises at least one ultrasonic sensor 35, 36, 37, 38. Each ultrasonic sensor is used to estimate at least one characteristic of the liquid film flowing along the wall of the pipe sections in a non-intrusive way. Examples of such characteristic may include, but should not be limited to, a thickness of the liquid film, a velocity of the liquid film, an average velocity of the liquid film, a velocity profile of the liquid film, a frequency of waves along an interface between the liquid film and the multiphase fluid mixture (13), a velocity of the waves, and an average height of the waves. Using techniques known in the art for measuring velocity of the liquid film, for example techniques such as pulsed ultrasonic Doppler discussed in GB2447490 (hereby incorporated by reference herein), can increase the accuracy of the multiphase fluid flow rate measurement when implemented in accordance with embodiments of the present invention. Although detailed description regarding the film thickness measurement is provided herein, a person skilled in the art will appreciate that such description may apply to other characteristics of the liquid film as well.

The thickness measurements are local, in the sense that only the film thickness of the fluid flowing in front of the ultrasonic sensor can be estimated. The ultrasonic sensors may be piezoelectric transducers working sequentially in emission and reception as known in the art. Various sensors 35, 36, 37 may be installed or inserted on the external side of the wall of the pipe section 21 of the multiphase flow meter 1 at different locations, for example close to the upstream part 23, and/or the throat 24, and/or the downstream part 25, respectively. Further, at least another sensor 38 may also be positioned on the external side of the wall of the first blind-T pipe section 20, for example close to the location where the pipe section 21 is coupled to the first blind-T pipe section 20. Any other position of the sensor facing a zone of the pipe where the multiphase fluid mixture 13 flows according to flow conditions similar to the ones expected at the Venturi throat may be convenient. The ultrasonic sensor may be positioned in a blind hole of the external side of the wall of the pipe section separated from the multiphase fluid mixture by the wall of the pipe, by a ceramic, a plastic, or any type of material suitable for withstanding the pressure of flow, and preferably a material with a suitable impedance for ultrasonic measurements of the multiphase fluid mixture 13. As such, the ultrasonic sensor may be screwed or strapped on the external side of the wall of the pipe section. Each ultrasonic sensor may be positioned such that the ultrasonic vibrations/waves propagates perpendicularly to the multiphase fluid mixture 13 flow direction (depicted as an arrow) or to the wall of the pipe section, or parallel to the beam of the fraction measurement device (e.g., the gamma densitometer). Thus, the positioning of said sensors does not affect the positioning of the other sensors, the tightness and the overall design of the multiphase flow meter 1. As described in details hereinafter, these sensors can measure accurately liquid film thickness and evolution of the liquid film along the pipe section, in particular at the measuring section.

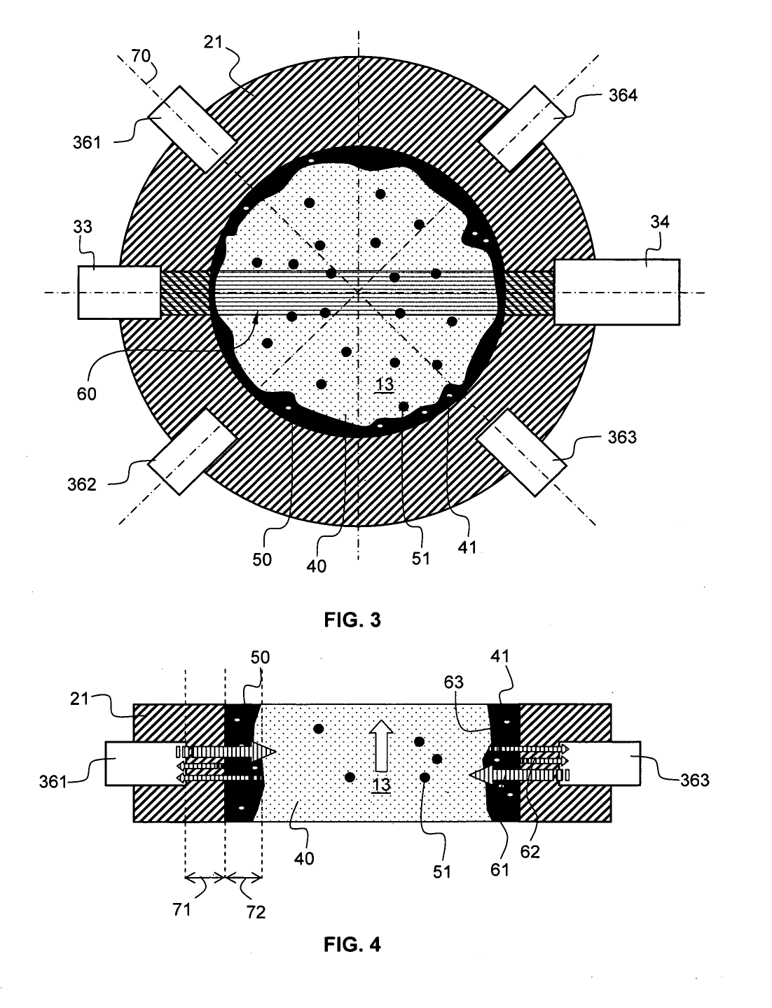

It is to be noted that, though, the pressure tapings 28, 29, the pressure sensors 31, 32, the gamma ray source 33 and detector 34, and the ultrasonic sensors 35, 36, 37, 38. have been depicted in the same plane in FIG. 2, this is only for a mere drawing simplicity reason. It may be apparent for the skilled person that said entities may be positioned around the pipe section in different planes as, for example, depicted in FIG. 3.

The pressure sensors 31, 32, the temperature sensor (not shown), the gamma ray detector 34, and the ultrasonic sensors 35, 36, 37, 38 are coupled to the control and data acquisition arrangement 16. An interface (not shown) may be connected between the various sensors and the control and data acquisition arrangement 16. Such an interface may comprise an analog-to-digital converter means, multiplexing means, wired or wireless communication means and electrical power means.

The control and data acquisition arrangement 16 may determine the total flowrate, the flow rates of the individual phases of the multiphase fluid mixture 13, the density of the multiphase fluid mixture 13, the temperature and other values based on measurements provided by the various sensors and detectors.

FIG. 3 is a top cross-sectional view schematically illustrating the throat of a Venturi flow meter according to a particular embodiment of the present invention. In this embodiment, four ultrasonic sensors 361, 362, 363, 364 are positioned around the throat, namely at the same crossing section as the gamma ray source 33 and the gamma ray detector 34. These sensors 361, 362, 363, 364 can measure the local film characteristics. For example a mean value of the characteristics (e.g., thickness and/or velocity) can be estimated from the measurement of the four ultrasonic sensors 361, 362, 363, 364. This estimation can be considered as a sufficiently accurate estimation of the film characteristics in the gamma densitometer beam 60.

Both FIGS. 3 and 4 schematically illustrate a situation of high gas volume fraction GVF. In such a situation, a main wet gas stream 40 with droplets of oil and water 51 flows in the core of the pipe section 21, while a film of liquid comprising oil and water 50 with bubbles of gas 41 flows along the wall of the pipe section 21. At high gas volume fraction GVF the accuracy of gamma densitometer can dramatically decrease. A high gas volume fraction GVF of the multiphase fluid mixture 13 is considered to be at least 90%.

FIG. 4 depicts a side cross-sectional view along line 70 of FIG. 3 illustrating the liquid film measurement principle.

Each ultrasonic sensor 361, 363 in transmission mode produces acoustic signals (vibrations/waves) 61 which are reflected at any interface met along their paths. The reflected acoustic signals (vibrations/waves) generate echoes which are measured by the ultrasonic sensor 361, 363 in reception mode. A first reflected acoustic signal 62 results from the acoustic signals 61 being partially reflected at the interface between the pipe section wall and the liquid film 50 on the wall. A second reflected acoustic signal 63 results from the acoustic signals 61 being partially reflected at the interface between the liquid film 50 and the gas stream 40.

Thus, the acoustic signals cross firstly a thickness of metal 71 and then a thickness of liquid 72. There are not any significant or measurable echoes occurring within the gas stream 40 due to the dispersion of the acoustic signals within the gas phase. Two echoes and their attached alias due to multiple reflections are received and recorded at the ultrasonic sensor. These echoes are processed and two transition times are calculated. These transition times are converted as thickness of metal 71 and thickness of liquid 72 using densities of each material and speed of ultrasonic signal in each material.

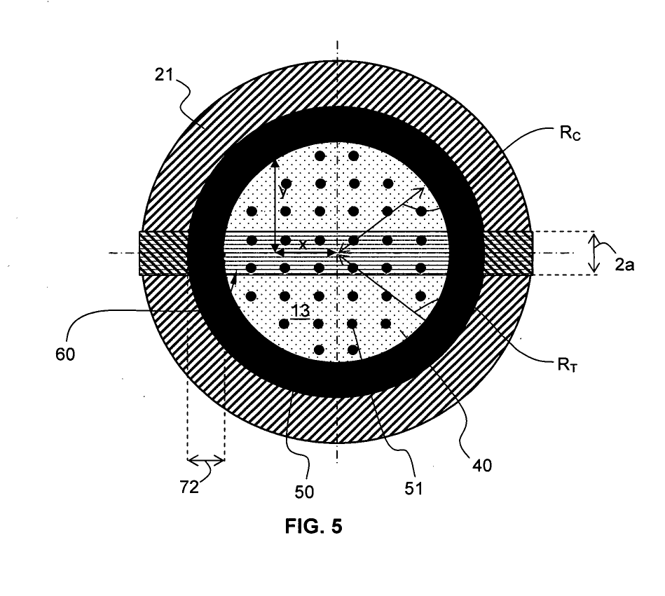

FIG. 5 is a top cross-sectional view in the throat of a Venturi flow meter depicting a theoretical situation of high gas volume fraction GVF with liquid film on the throat wall and droplets in the throat core for the purpose of illustrating the various dimensions of the hereinafter formulae.

In the example of high gas volume fraction GVF depicted on FIG. 5, the fluid mixture 13 flowing through the Venturi throat comprises a gas core with droplets and a liquid film on the wall. The diameter of the core in this example is approximately 75% of the total throat diameter. So assuming a pure gas core the gas fraction is about 50% and looking at the fluid distribution within the beam limits, it can be seen that the gas core occupies much more than 50% of the total beam area. Thus the gas fraction measured in the beam will be significantly higher than the true gas fraction in the pipe. The effect of this error is reduced when there are also droplets of liquid present in the core (as shown).

It is assumed that the film thickness 72 or a mean value of the film thickness (see the embodiment of FIG. 3) is measured at the location where the fractions are measured with the gamma densitometer. The liquid film is assumed in this example to be a perfect annulus.

Further, it is assumed for simplification reasons that the geometry is two-dimensional 2-D, i.e. the beam 60 of the gamma densitometer is represented by a cross section through its widest part instead of by a cylinder. A full three dimensional 3-D calculation is possible but will not significantly change the results obtained.

The Venturi throat has a radius R_{T}. The core, which is estimated to be a homogeneous mixture of gas and liquid droplets, has a radius of R_{C}. The radius of the beam is a.

The area of the core (droplets+gas) within the beam A_{BC} can be calculated by:

A_{BC}=4∫₀^{a}\sqrt{R_{C}²−x²}dx (1)

Which can be solved as a standard integral giving:

$${A}_{BC} = 4 [ \frac{{R}_{C}^{2}}{2} ( a sin ( \frac{a}{{R}_{C}} ) + \frac{a}{{R}_{C}^{2}} \sqrt{{R}_{C}^{2} - {a}^{2}} ) ] \qquad ( 2 )$$

Similarly the total area (core+film) within the beam A_{B} can be calculated by:

A_{B}=4∫₀^{a}\sqrt{R_{T}²−x²}dx (3)

Which can be solved as a standard integral giving:

$${A}_{B} = 4 [ \frac{{R}_{T}^{2}}{2} ( a sin ( \frac{a}{{R}_{T}} ) + \frac{a}{{R}_{T}^{2}} \sqrt{{R}_{T}^{2} - {a}^{2}} ) ] \qquad ( 4 )$$

The area occupied by the film A_{BC} is the difference of these two areas:

A_{BF}=A_{B}−A_{BC} (5)

This calculation assumes the core diameter is greater than the beam diameter. The area though the beam occupied by droplets is A_{BCD}.

The fraction of liquid measured by the gamma densitometer beam is:

$${α}_{L} = \frac{{A}_{BF} + {A}_{BCD}}{{A}_{B}} \qquad ( 6 )$$

The area occupied by the droplets within the beam is:

A_{BCD}=A_{B}×α_{L}−A_{BF} (7)

Furthermore, it is assumed that the droplets 51 are distributed homogeneously within the core. Consequently the fraction of droplets through the beam can be considered as equivalent to the fraction of droplets over the throat area. The fraction of droplets over the throat area is:

$${α}_{Droplets}^{Throat} = \frac{{A}_{BCD}}{{A}_{B}} = {α}_{L} - \frac{{A}_{BF}}{{A}_{B}} \qquad ( 8 )$$

The real fraction of liquid as a film over the throat wall is:

$${α}_{Film}^{Throat} = \frac{{R}_{T}^{2} - {R}_{C}^{2}}{{R}_{T}^{2}} \qquad ( 9 )$$

Finally the real liquid fraction over the throat is:

$$\begin{matrix}{α}_{Liquid}^{Throat} = {α}_{Film}^{Throat} + {α}_{Droplets}^{Throat} \\ = {α}_{L} - \frac{{A}_{BF}}{{A}_{B}} + \frac{{R}_{T}^{2} - {R}_{C}^{2}}{{R}_{T}^{2}}\end{matrix} \qquad ( 10 )$$

Thus, knowing the dimension of the Venturi throat and the dimension of the beam (both are known with the corresponding tolerance during the manufacturing process of the multiphase flow meter), and measuring the thickness of the film 72, it is possible to correct the liquid fraction, and consequently also the gas fraction, measured by the gamma densitometer.

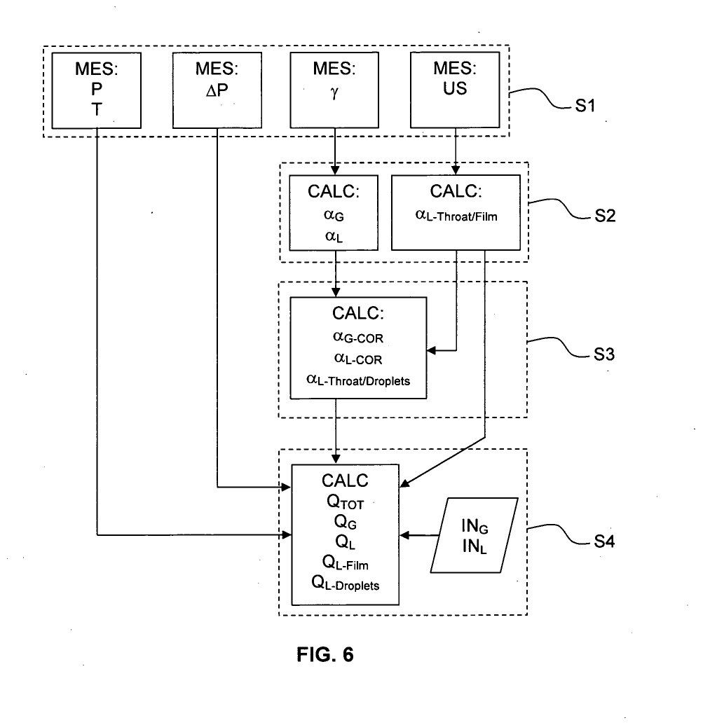

FIG. 6 schematically illustrates the method for calculating flow rate measurements of the present invention.

In a first step S1, various measurements are performed as explained in details hereinbefore in relation with FIG. 2, namely:
differential pressure ΔP measurements;
gamma attenuation γ measurements;
ultrasonic US measurements; and
pressure P and temperature T measurements.

In a second step S2, two series of calculation are performed. Firstly, the gas fraction α_{G} and the liquid fraction α_{L} are estimated from, for example, the attenuation measurements of the gamma densitometer. Secondly, the fraction of liquid as a film at the throat α_{L-Throat/Film} can be calculated from the ultrasonic measurements.

In a third step S3, the estimated gas fraction α_{G} and the liquid fraction α_{L} can be corrected from the calculated fraction of liquid as a film at the throat α_{L-Throat/Film}. Corrected gas fraction α_{G-COR} and liquid fraction α_{L-COR} are calculated. A fraction of liquid as droplets at the throat α_{L-Throat/Droplets} can be calculated using the equation:

α_{L-Throat/Droplets}=1−α_{G-COR}−α_{L-Throat/Film} (11)

In a fourth step S4, the flow rate of the gas phase Q_{G}, the flow rate of the liquid phase Q_{L}, the flow rate of the liquid as a film Q_{L-Film} and/or the flow rate of the liquid as droplets Q_{L-Droplets} can be calculated based on the differential pressure ΔP measurements, the corrected gas fraction α_{G-COR}, the liquid film fraction α_{L-Throat/Film}, and the liquid droplet fraction α_{L-Throat/Droplets} This calculation may also take into consideration fluid properties, such as, but not limited to, density, viscosity, and surface tension, related to the gas IN_{G} or the liquid IN_{L} inputs known or obtained from calibration of the multiphase flow meter, and/or effect of actual pressure P and temperature T conditions of the multiphase fluid mixture 13 during the measurements. Thus, the performance of the multiphase flow meter can be improved.

It should be appreciated that embodiments of the present invention are not limited to onshore hydrocarbon wells and can also be used offshore. Furthermore, although some embodiments have drawings showing a horizontal well bore and a vertical well bore, said embodiments may also apply to a deviated well bore. All the embodiments of the present invention are equally applicable to cased and uncased borehole (open-hole). Although particular applications of the present invention relate to the oilfield industry, other applications to other industries, for example the mining industry or the like may also apply. The apparatus of the present invention is applicable to various hydrocarbon exploration and production related applications, for example permanent well monitoring applications wherein several multiphase flow meters are positioned at various locations in the well.

Though, the present invention is described in conjunction with a Venturi flow meter, what is important is the generation of a pressure drop when the multiphase fluid mixture 13 flows through the multiphase flow meter. As mentioned hereinbefore, this could also be obtained with a V-cone, or orifice plate type flow meter.

The drawings and their description hereinbefore illustrate rather than limit the present invention.

Although a drawing shows different functional entities as different blocks, this by no means excludes implementations in which a single entity carries out several functions, or in which several entities carry out a single function. In this respect, the drawings are very diagrammatic.

Any reference sign in a claim should not be construed as limiting the claim. The word “comprising” does not exclude the presence of other elements than those listed in a claim. The word “a” or “an” preceding an element does not exclude the presence of a plurality of such element.

1. A flow meter for measuring a flow rate of a multiphase fluid mixture comprising at least one gas phase and one liquid phase, the flow meter comprising:
a pipe section through which the multiphase fluid mixture flows, the pipe section comprising a measurement section;
a fraction measurement device estimating a representative fraction of at least one of the gas phase and the liquid phase of the multiphase fluid mixture passing at the measurement section; and
at least one ultrasonic sensor arranged to estimate at least one characteristic of a portion of the liquid phase flowing as a liquid film along a wall of the pipe section, the at least one characteristic being used to correct the estimated representative fraction of at least one of the gas phase and the liquid phase when the gas phase flows in a core of the pipe section, and a portion of the liquid phase flows partially as the liquid film along the wall of the pipe section and another portion of the liquid phase flows partially as liquid droplets in the core of the pipe section.

2. The flow meter according to claim 1, wherein at least one ultrasonic sensor is positioned at the measurement section.

3. The flow meter according to claim 1, wherein at least one ultrasonic sensor is positioned at a position such as to face a zone of the pipe section where the multiphase flow mixture flows according to conditions similar to the conditions expected at the measurement section.

4. The flow meter according to claim 1, wherein the at least one characteristic of a portion of the liquid phase flowing as a liquid film along a wall of the pipe section is selected from the group consisting of: a thickness of the liquid film, a velocity of the liquid film, an average velocity of the liquid film, a velocity profile of the liquid film, a frequency of waves along an interface between the liquid film and the multiphase fluid mixture, a velocity of the waves, and an average height of the waves.

5. The flow meter according to claim 1, wherein the measurement section is defined as a throat of the pipe section and is located between an upstream part and a downstream part such as to generate a pressure drop between the upstream part and the downstream part.

6. The flow meter according to claim 1, wherein a plurality of ultrasonic sensors is positioned on a same plane perpendicular to the multiphase fluid mixture flow direction such as to estimate a mean value of the at least one characteristic of a portion of the liquid phase flowing as a liquid film along a wall of the pipe section.

7. The flow meter according to claim 1, wherein the fraction measurement device is a gamma densitometer.

8. The flow meter according to claim 7, wherein the at least one ultrasonic sensor is positioned such that ultrasonic waves propagate parallel to a beam of the gamma densitometer.

9. The flow meter according to claim 1, wherein the at least one ultrasonic sensor is installed on a face of the pipe section not contacting the multiphase fluid mixture.

10. The flow meter according to claim 1, wherein the at least one ultrasonic sensor is installed in the wall of the pipe section.

11. The flow meter according to claim 5, wherein the flow meter further comprises:
pressure tapings; and
at least one pressure sensor for measuring the differential pressure of the multiphase fluid mixture between the upstream part and the measurement section.

12. The flow meter according to claim 11, wherein at least one ultrasonic sensor is positioned proximate the pressure tapings to define a plane perpendicular to the multiphase fluid mixture flow direction.

13. The flow meter according to claim 1, wherein the pipe section is connected at least on one end to a blind-T pipe section.

14. The flow meter according to claim 1, wherein the multiphase fluid mixture is a hydrocarbon effluent comprising gas, oil, and water.

15. A method for measuring a flow rate of a multiphase fluid mixture comprising a gas phase and a liquid phase, the flow rate measuring method comprising:
generating a pressure drop between an upstream part and a downstream part of a flow meter by flow of the multiphase fluid mixture in a pipe section of the flow meter having a measurement section positioned between the upstream part and the downstream part;
submitting the multiphase fluid mixture to gamma rays, measuring an absorption of the gamma rays by at least one of the gas phase and the liquid phase passing at the measurement section and estimating a representative fraction of at least one of the gas phase and the liquid phase in the multiphase fluid mixture;
estimating at least one characteristic of a portion of the liquid phase flowing as a liquid film along a wall of the measurement section using at least one ultrasonic sensor;
correcting the estimated representative fraction of at least one of the gas phase and the liquid phase based on the at least one characteristic when the gas phase flows in a core of the pipe section, and a portion of the liquid phase flows partially as the liquid film along the wall of the pipe section and another portion of the liquid phase flows partially as liquid droplets in the core of the pipe section; and
calculating the flow rate QTOT of the multiphase fluid mixture based on the corrected representative fraction of at least one of the gas phase and the liquid phase.

16. The method for measuring a flow rate of a multiphase fluid mixture according to claim 15, wherein the at least one characteristic is estimated at a position facing a zone of the pipe section where the multiphase fluid mixture flows according to conditions similar to the conditions expected at the measurement section.

17. The method for measuring a flow rate of a multiphase fluid mixture according to claim 15, wherein the at least one characteristic of a portion of the liquid phase flowing as a liquid film along a wall of the pipe section is selected from the group consisting of: a thickness of the liquid film, a velocity of the liquid film, an average velocity of the liquid film, a velocity profile of the liquid film, a frequency of waves along an interface between the liquid film and the multiphase fluid mixture, a velocity of the waves, and an average height of the waves.

18. The method for measuring a flow rate of a multiphase fluid mixture according to claim 15, wherein calculating the flow rate QTOT of the multiphase fluid mixture includes calculating at least one of a flow rate QG of the gas phase, a flow rate QL of the liquid phase, a flow rate QL-Film of the liquid film portion of the liquid phase, and a flow rate QL-Droplets of the liquid droplets portion of the liquid phase.

19. The method for measuring a flow rate of a multiphase fluid mixture according to claim 15, wherein the at least one characteristic is estimated by a mean value of the liquid film thickness by means of a plurality of ultrasonic sensor positioned on a same plane perpendicular to the multiphase fluid mixture flow direction.

20. The method for measuring a flow rate of a multiphase fluid mixture according to claim 15, wherein the method further comprises:
measuring the differential pressure of the multiphase fluid mixture between the upstream part and downstream part.
